(19) United States
(12) Patent Application Publication
(10) Pub. No.: US 2026/0277135 A1
(43) Pub. Date: Sep. 17, 2026

(54) TONER CONVEYING DEVICE, AND DEVELOPING DEVICE AND IMAGE FORMING APPARATUS THEREWITH

(71) Applicant: KYOCERA Document Solutions Inc., Osaka (JP)

(72) Inventors: Susumu TANIGUCHI, Osaka (JP); Takeshi IKETANI, Osaka (JP)

(73) Assignee: KYOCERA Document Solutions Inc., Osaka (JP)

(21) Appl. No.: 19/560,867

(22) Filed: Mar. 9, 2026

(30) Foreign Application Priority Data
Mar. 11, 2025 (JP) 2025-038436

(51) Int. Cl. G03G 15/08; G03G 15/01

(52) U.S. Cl. CPC G03G 15/0891; G03G 15/0872; G03G 15/0889; G03G 15/0121; G03G 15/0189

(57) ABSTRACT

A toner conveying device incudes a vertical conveying portion, a horizontal conveying portion, a conveying member, and a loosening member. The vertical conveying portion conveys toner, or developer containing toner, by letting it fall vertically. The horizontal conveying portion is coupled to a lower end part of the vertical conveying portion and conveys, with a conveying member, the toner or developer horizontally. The loosening member has a wound spring portion and a weight fixed to a lower end part of the wound spring portion. In the wound spring portion, a press-in portion in a hollow cylindrical shape is formed in which turns of the metal wire material are put in close contact together. The weight has an inserted portion press-fitted in the press-in portion and a projecting portion rising from an outer circumferential edge of an upper end part of the inserted portion so as to taper off upward.

### INCORPORATION BY REFERENCE

This application is based on and claims the benefit of priority from Japanese Patent Application No. 2025-038436 filed on Mar. 11, 2025, the contents of which are hereby incorporated by reference.

### BACKGROUND

The present disclosure relates to a toner conveying device for conveying toner. More particularly, the present disclosure relates to a toner conveying device including a toner conveying portion having a horizontal conveying portion coupled to a lower end part of a vertical conveying portion through which toner is let to fall vertically, and to a developing device and an image forming apparatus provided with such a toner conveying device.

An electrophotographic image forming apparatus such as a printer or a copier includes a photosensitive drum that carries an electrostatic latent image, a developing device that feeds toner to the photosensitive drum to develop the electrostatic latent image into a toner image, and a toner container that supplies toner to the developing device. In a color image forming apparatus, a layout can be employed in which an intermediate transfer unit is interposed between the toner container and the developing device. In this layout, the toner container and the developing device are located apart from each other and thus, to convey toner from a toner discharge port of the toner container to a toner inlet port of the developing device, a toner conveying portion is provided.

Here, if the toner container can be disposed right above the developing device, the toner conveying portion need only have a vertical conveying portion through which toner is let to fall vertically. However, in a layout that does not permit the toner container to be disposed right above the developing device, the toner conveying portion needs to have, in addition to the vertical conveying portion, a horizontal conveying portion that conveys toner horizontally. In the horizontal conveying portion, a conveying screw is disposed to convey toner.

In a toner conveying portion that has a horizontal conveying portion coupled to a vertical conveying portion, toner may agglomerate near a lower end part of the vertical conveying portion (the part coupled to the horizontal conveying portion) and, inconveniently, this may hamper smooth supply of toner. The cause is that, as the conveying screw rotates, the toner near the lower end part of the vertical conveying portion is pushed back upward so that the toner agglomerates and clumps (blocking) to stagnate and clog the conveying passage.

### SUMMARY

According to one aspect of the present disclosure, a toner conveying device includes a vertical conveying portion, a horizontal conveying portion, a conveying member, and a loosening member, and is removably mounted in an image forming apparatus. The vertical conveying portion has, formed in an upper end part of it, an inlet port coupled to a body-side conveying passage in the image forming apparatus. The vertical conveying portion conveys toner, or developer containing toner, carried in via the inlet port, by letting it fall vertically. The horizontal conveying portion is coupled to a lower end part of the vertical conveying portion, and conveys the toner or developer horizontally. The conveying member has a rotation shaft disposed along the conveying direction of the toner or developer in the horizontal conveying portion and a conveying projection provided on the outer circumferential surface of the rotation shaft. The conveying member rotates the rotation shaft to convey, with the conveying projection, the toner or developer in the horizontal conveying portion along the direction of the rotation shaft. The loosening member is disposed in the vertical conveying portion so as to be vertically movable in it. The loosening member includes a wound spring portion formed by curling a metal wire material into a spiral shape and a weight fixed to a lower end part of the wound spring portion. In the wound spring portion, a press-in portion in a hollow cylindrical shape is formed in which turns of the metal wire material are put in close contact together. The weight has an inserted portion that is in a cylindrical shape with an outer diameter larger than the inner diameter of the press-in portion in a state with no external force acting thereon and that is press-fitted in the press-in portion, and a projecting portion that rises from an outer circumferential edge of an upper end part of the inserted portion so as to taper off upward.

### BRIEF DESCRIPTION OF THE DRAWINGS

FIG. 1 is a schematic sectional view of an image forming apparatus that incorporates a developing device to which a toner supplying portion according to the present disclosure is coupled.

FIG. 2 is a perspective view of the developing device incorporated in the image forming apparatus.

FIG. 3 is a side sectional view of the developing device.

FIG. 4 is a side view of the developing device as seen from where the toner supplying portion is located.

FIG. 5 is a sectional view of the toner supplying portion and a stirring conveying chamber in the developing device as cut along the axial direction of a stirring conveying screw.

FIG. 6 is an enlarged sectional view around the coupled parts of a wound spring portion and a weight of a loosening member disposed in a vertical conveying portion of the toner supplying portion.

### DETAILED DESCRIPTION

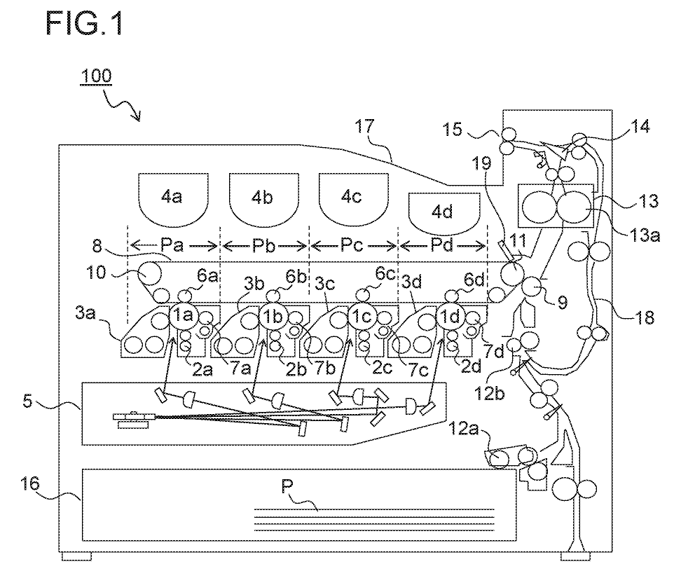

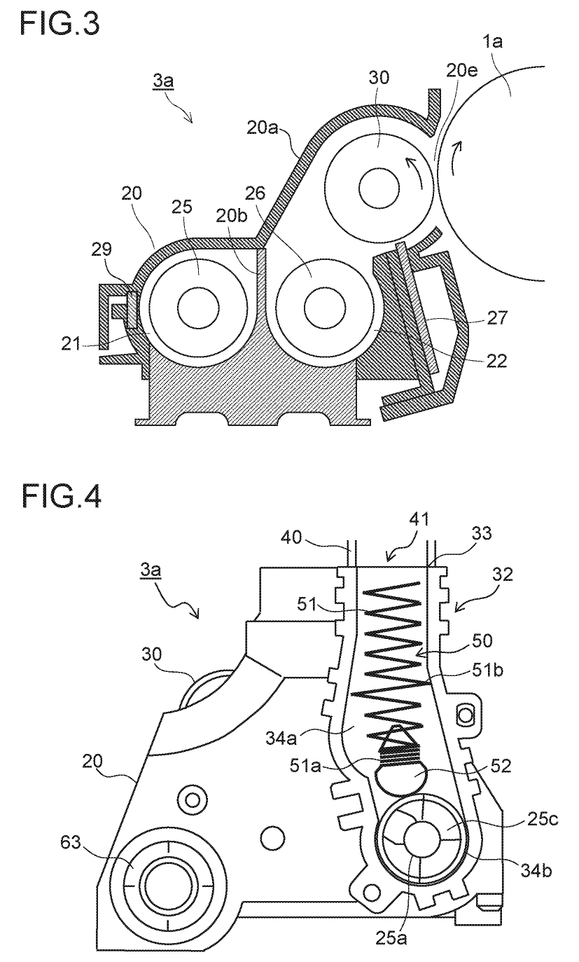

An embodiment of the present disclosure will be described below with reference to the accompanying drawings. FIG. 1 is a sectional view showing the internal construction of an image forming apparatus 100 provided with developing devices 3a to 3d to which a toner supplying portion 32 (see FIG. 3) according to the present disclosure is coupled. In a body of the image forming apparatus 100 (here, a color printer), four image forming portions Pa, Pb, Pc, and Pd are disposed in this order from upstream (left in FIG. 1) along the conveying direction. These image forming portions Pa to Pd are provided for images of four different colors (yellow, cyan, magenta, and black) and sequentially form a yellow, a cyan, a magenta, and a black image respectively, each through the processes of electrostatic charging, light exposure, image development, and image transfer.

In these image forming portions Pa to Pd, photosensitive drums (image carriers) 1a, 1b, 1c, and 1d that carry visible images (toner images) of the different colors are disposed. Moreover, adjacent to the image forming portions Pa to Pd, an intermediate transfer belt (intermediate transferring member) 8 that rotates counterclockwise in FIG. 1 by being driven by a belt driving motor (not shown) is provided.

When image data is fed in from a host device such as a personal computer, first, a main motor 40 (see FIG. 10) starts to rotate the photosensitive drums 1a to 1d. Then, charging devices 2a to 2d electrostatically charge the surfaces of the photosensitive drums 1a to 1d uniformly. Next, an exposure device 5 emits light according to the image data so as to form electrostatic latent images according to the image data on the photosensitive drums 1a to 1d. The developing devices 3a to 3d are loaded with predetermined amounts of two-component developer containing yellow, cyan, magenta, and black toner respectively. As toner images are formed as described later, when the proportion of the toner in the two-component developer loaded in the developing devices 3a to 3d falls below a prescribed value, toner is supplied from toner containers 4a to 4d to the developing devices 3a to 3d. The toner in the developer is fed by the developing devices 3a to 3d to the photosensitive drums 1a to 1d and electrostatically attaches to them. In this way, toner images are formed according to the electrostatic latent images formed by exposure to the light from the exposure device 5.

Then, primary transfer rollers 6a to 6d produce electric fields with a predetermined transfer voltage between the primary transfer rollers 6a to 6d and the photosensitive drums 1a to 1d, so that the yellow, cyan, magenta, and black toner images on the photosensitive drums 1a to 1d are primarily transferred to an intermediate transfer belt 8. The toner and the like left on the surfaces of the photosensitive drums 1a to 1d after primary transfer are removed by cleaning devices 7a to 7d.

Transfer sheets P to which toner images are to be secondarily transferred are stored in a sheet cassette 16 disposed in a lower part of the body of the image forming apparatus 100, and are conveyed via a sheet feed roller 12a and a pair of registration rollers 12b to a nip portion between a secondary transfer roller 9 and a driving roller 11 for the intermediate transfer belt 8. Downstream of the secondary transfer roller 9, a belt cleaner 19 in a blade form is disposed that removes the toner and the like left on the surface of the intermediate transfer belt 8.

A transfer sheet P conveyed to a fixing portion 13 is heated and pressed by a pair of fixing rollers 13a to have the toner images fixed to the surface of the transfer sheet P, so that a predetermined full-color image is formed. The transfer sheet P having the full-color image formed on it has its conveying direction switched by a branch portion 14 that branches into a plurality of direction to be discharged as it is (or after being fed to a duplex conveying passage 18 to have images formed on both sides) to a discharge tray 17 by a pair of discharge rollers 15.

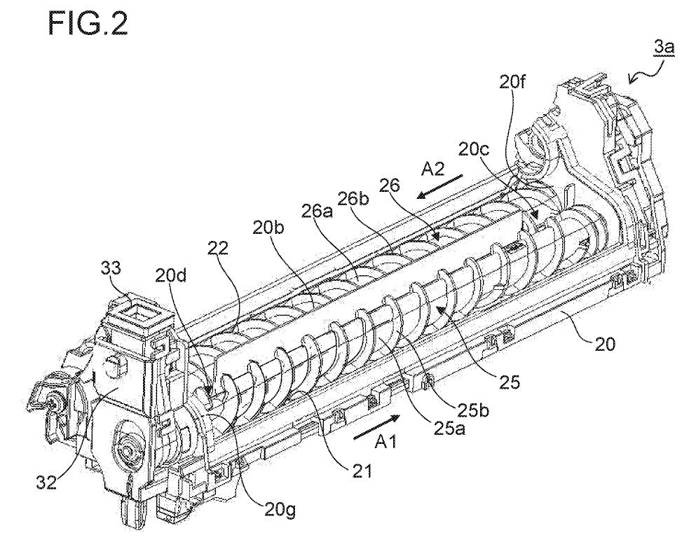

FIG. 2 is a perspective view of the developing device 3a incorporated in the image forming apparatus 100. FIG. 3 is a side sectional view of the developing device 3a. Note that, in FIG. 2, a cover member 20a of a developer container 20 and a developing roller 31 are omitted from illustration. The following description focuses on the developing device 3a disposed in the image forming portion Pa in FIG. 1. The developing devices 3b to 3d disposed in the image forming portions Pb to Pd are basically configured similarly and therefore, for them, no description will be repeated. The developing devices 3a to 3d are removably mounted in the image forming apparatus 100.

As shown in FIGS. 2 and 3, the developing device 3a includes a developer container 20 that stores two-component developer (in the following description also referred to simply as developer) containing magnetic carrier and toner. The developer container 20 includes a cover member 20a, a partition wall 20b, a first communication portion 20c, a second communication portion 20d, a stirring conveying chamber 21, a feeding conveying chamber 22, and a toner supplying portion 32.

The cover member 20a is removably fitted to a body of the developer container 20 and constitutes an upper part of the developer container 20. The partition wall 20b divides the interior of the developer container 20 into the stirring conveying chamber 21 and the feeding conveying chamber 22, which are disposed side by side. Through the first and second communication portions 20c and 20d, the stirring conveying chamber 21 and the feeding conveying chamber 22 communicate with each other in opposite end parts of the partition wall 20b along its longitudinal direction.

In the stirring conveying chamber 21 and the feeding conveying chamber 22, a stirring conveying screw 25 and a feeding conveying screw 26, respectively, are rotatably arranged that mix, stir, and electrostatically charge the toner fed from the toner container 4a (see FIG. 1) with the magnetic carrier. Used in the embodiment is a two-component developer containing a positively chargeable toner and a ferrite resin-coated carrier.

The stirring conveying screw 25 has a rotation shaft 25a and a first conveying blade 25b formed in a spiral shape with a fixed pitch along the axial direction of the rotation shaft 25a. The rotation shaft 25a and the first conveying blade 25b are integrally molded from a synthetic resin. The first conveying blade 25b extends up to opposite end parts of the stirring conveying chamber 21 along the longitudinal direction, up to positions at which it faces the first and second communication portions 20c and 20d. The rotation shaft 25a is rotatably pivoted on a first and a second side wall portion 20f and 20g of the developer container 20. The stirring conveying screw 25 conveys, while stirring, the developer in the stirring conveying chamber 21 in a fixed direction (arow A1 direction).

The feeding conveying screw 26 has a rotation shaft 26a and a second conveying blade 26b formed in a spiral shape with a fixed pitch along the axial direction of the rotation shaft 26a. The rotation shaft 26a and the second conveying blade 26b are integrally molded from a synthetic resin. The second conveying blade 26b has a length greater than the length of a developing roller 30 along the axial direction, and extends up to positions at which it faces the first and second communication portions 20c and 20d. The rotation shaft 26a is disposed parallel to the rotation shaft 25a, and is rotatably pivoted on the first and second side wall portions 20f and 20g of the developer container 20. The feeding conveying screw 26 conveys, while stirring, the developer in the feeding conveying chamber 22 in the direction (arow A2 direction) opposite to the stirring conveying screw 25.

By the stirring conveying screw 25 and the feeding conveying screw 26, the developer is, while being stirred, conveyed in the axial direction (the direction perpendicular to the plane of FIG. 3) to circulate, via the first and second communication portions 20c and 20d formed in opposite end parts of the partition wall 20b, between the stirring conveying chamber 21 and the feeding conveying chamber 22. Thus, the stirring conveying chamber 21, the first communication portion 20c, the feeding conveying chamber 22, and the second communication portion 20d constitute a circulation passage for developer within the developer container 20.

The developer container 20 extends obliquely to the upper right in FIG. 3. Inside the developer container 20, obliquely to the upper right of the feeding conveying screw 26, a developing roller 30 is disposed. Part of the outer circumferential surface of the developing roller 30 is exposed through an opening 20e in the developer container 20 to face the photosensitive drum 1a across a predetermined interval (development gap). The developing roller 30 rotates counterclockwise in FIG. 3 (it rotates by trailing the photosensitive drum 1a at a position opposite it).

The developing roller 30 is composed of a developing sleeve in a cylindrical shape that rotates counterclockwise in FIG. 3 and a magnet (not shown) that is fixed inside the developing sleeve and that has a plurality of magnetic poles. While here a developing sleeve with a knurled surface is used, it is also possible to use one with a number of depressions (dimples) formed in its surface, or a developing sleeve with a blasted surface, one with a surface knurled and having depressions formed in it and in addition blasted, one plated for improved durability, one anodized, one anodized and then having a salt of metal such as Ni, Sn, or Mo applied to porous parts formed by anodizing, that is, one treated by what is called secondary electrolytic coloring. The developing roller 30 is fed with a developing voltage containing a direct-current voltage and an alternative-current voltage that is supplied from a developing voltage power source (not shown).

The developer container 20 is fitted with a regulating blade 27 along the longitudinal direction of the developing roller 30 (the direction perpendicular to the plane of FIG. 3). Between a tip part of the regulating blade 27 and the developing roller 30, a small clearance (gap) is left. In the embodiment, used as the regulating blade 27 is a magnetic blade made of stainless steel (SUS430).

At a side surface of the stirring conveying chamber 21, a toner concentration sensor 29 is disposed opposite the stirring conveying screw 25. The toner concentration sensor 29 senses the toner concentration in the developer (the mix ratio of toner to carrier in the developer, T/C) in the developer container 20. Used as the toner concentration sensor 29 is, for example, a magnetic permeability sensor that senses the magnetic permeability of the two-component developer containing toner and magnetic carrier in the developer container 20. According to the toner concentration sensed by the toner concentration sensor 29, the toner in the toner container 4a (see FIG. 1) is supplied via the toner supplying portion 32 into the developer container 20.

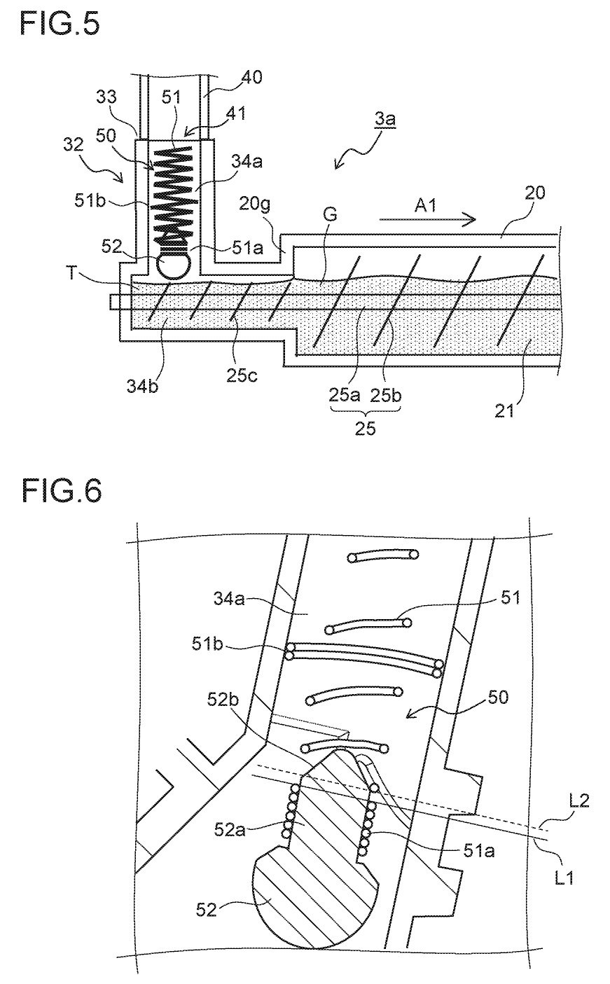

The toner supplying portion 32 is provided upstream with respect to the developer conveying direction (arrow A1 direction) in the stirring conveying chamber 21. The toner supplying portion 32 includes a toner supply port 33, a vertical conveying portion 34a, and a horizontal conveying portion 34b (for these, see FIGS. 4 and 5). The toner supply port 33 is open in an upper part of the toner supplying portion 32, and is coupled to a body-side conveying passage 40 (see FIG. 4) that extends downward from the toner container 4a (see FIG. 1).

FIG. 4 is a side view of the developing device 3a as seen from where the toner supplying portion 32 is located. FIG. 5 is a sectional view of the toner supplying portion 32 and the stirring conveying chamber 21 in the developing device 3a as cut along the axial direction of the stirring conveying screw 25. In FIG. 4, an outer cover is removed to expose the interior of the toner supplying portion 32.

As shown in FIG. 4, the developer container 20 is fitted with a drive input gear 63 in an end part of it where the toner supplying portion 32 is located. The drive input gear 63 feeds a driving force from a development drive motor (not shown) to the stirring conveying screw 25, the feeding conveying screw 26, and the developing roller 30 in the developing device 3a.

The vertical conveying portion 34a vertically conveys (lets fall) the toner carried in through the toner supply port 33. Below the vertical conveying portion 34a, the horizontal conveying portion 34b extends horizontally. The horizontal conveying portion 34b receives toner from the vertical conveying portion 34a and conveys it horizontally. The horizontal conveying portion 34b communicates with the stirring conveying chamber 21 from upstream of it (left in FIG. 5) with respect to the developer conveying direction (arrow A1 direction) in the stirring conveying chamber 21.

The rotation shaft 25a of the stirring conveying screw 25 penetrates the second side wall portion 20g of the developer container 20 and extends into the horizontal conveying portion 34b of the toner supplying portion 32. A part of the rotation shaft 25a disposed in the horizontal conveying portion 34b has integrally formed on it a supplying blade 25c that is formed in a spiral shape with a fixed pitch along the axial direction of the rotation shaft 25a. The supplying blade 25c is formed as a blade in a spiral shape with the same winding direction (same phase) as the first conveying blade 25b, and is formed with a smaller pitch and a smaller diameter than the first conveying blade 25b. That is, the stirring conveying screw 25 serves also as a conveying member that conveys the toner in the horizontal conveying portion 34b toward the stirring conveying chamber 21.

The toner conveyed from the toner container 4a via the body-side conveying passage 40 to the toner supply port 33 passes through the vertical conveying portion 34a to fall into the horizontal conveying portion 34b. The toner that has fallen into the horizontal conveying portion 34b is conveyed horizontally (rightward in FIG. 5) by the supplying blade 25c of the stirring conveying screw 25 to enter the stirring conveying chamber 21 along the rotation shaft 25a. It is then stirred and mixed with the developer in the stirring conveying chamber 21 (the developer circulating from the feeding conveying chamber 22 via the second communication portion 20d) to be electrically discharged to have a predetermined amount of charge.

In the vertical conveying portion 34a, a loosening member 50 is disposed. The loosening member 50 is composed of a wound spring portion 51 and a weight 52. The wound spring portion 51 is formed by curing a metal wire material (spring material) into a spiral shape. An upper end part of the wound spring portion 51 is not fixed in the vertical conveying portion 34a and is left as a free end. That is, the loosening member 50 is movable in the up-down direction inside the vertical conveying portion 34a.

The wound spring portion 51 has a press-in portion 51a and a support portion 51b. The press-in portion 51a is formed in a lower end part of the wound spring portion 51. The press-in portion 51a is formed in a hollow cylindrical shape by curling a metal wire material (spring material) into a spiral shape such that adjacent turns of the metal wire material are put in close contact together. The support portion 51b is formed above the press-in portion 51a. The outer diameter of the support portion 51b is larger than that of the other part of the wound spring portion 51 and is slightly smaller than the inner diameter of the vertical conveying portion 34a. Forming the support portion 51b in the wound spring portion 51 helps stabilize the posture of the loosening member 50 inside the vertical conveying portion 34a.

The weight 52 is formed of metal and is press-fitted in the press-in portion 51a of the wound spring portion 51 to be fixed there. The weight 52 lies in contact with the outer circumferential edge of the supplying blade 25c in the horizontal conveying portion 34b.

Next, the up-down movement of the loosening member 50 will be described. When a rotational driving force is fed to the stirring conveying screw 25 via the drive input gear 63, the stirring conveying screw 25 rotates. As a result, the supplying blade 25c integrally formed on the stirring conveying screw 25 rotates. Here, since the supplying blade 25c is in a spiral shape, the height of the part of the supplying blade 25c in contact with the weight 52 varies cyclically.

Specifically, as the supplying blade 25c rotates such that the height of the part of the supplying blade 25c in contact with the weight 52 reduces, the weight 52 moves down under its self weight. As a result, the wound spring portion 51 too moves down. When the weight 52 lowers until it makes contact with the rotation shaft 25a, the wound spring portion 51 lowers to the lowest point in the vertical conveying portion 34a.

As the supplying blade 25c further rotates such that the height of the part of the supplying blade 25c in contact with the weight 52 increases, the weight 52 is raised by the supplying blade 25c to move up. As a result, the wound spring portion 51 too moves up. When the weight 52 raises as far as the outer diameter of the supplying blade 25c, the wound spring portion 51 rises to the highest point in the vertical conveying portion 34a.

In this way, inside the horizontal conveying portion 34b, the wound spring portion 51 moves up and down to perform scraping-off action all the time. This helps prevent stagnation of toner (toner clogging) in the vertical conveying portion 34a.

It is thus possible to supply toner from the toner container 4a to developing device 3a smoothly and reliably with a simple configuration. It is also possible to minimize the printing wait time (downtime) on the image forming apparatus 100 due to failure to supply toner.

Moreover, the loosening member 50 reciprocates up and down by being driven by a driving source shared with the developing device 3a. This eliminates the need for a separate driving source for making the loosening member 50 reciprocate. It is thus possible to effectively suppress agglomeration (blocking) of toner in the vertical conveying portion 34a with a simple configuration and at low cost.

FIG. 6 is an enlarged sectional view around the coupled parts of the wound spring portion 51 and the weight 52 of the loosening member 50 disposed in the vertical conveying portion 34a of the toner supplying portion 32. As shown in FIG. 6, the weight 52 has an inserted portion 52a. The inserted portion 52a is in a cylindrical shape with an outer diameter slightly larger than the inner diameter of the press-in portion 51a in a state with no external force acting on it. Press-fitting the inserted portion 52a into the press-in portion 51a results in the weight 52 being fixed in a lower end part of the wound spring portion 51.

The inserted portion 52a has formed in an upper end part of it a projecting portion 52b in a conical shape. More specifically, the projecting portion 52b is in a conical shape rising from the outer circumferential edge of an upper end part of the inserted portion 52a so as to taper off upward.

Thus, toner that falls from above in the vertical conveying portion 34a slides down the side face (inclined face) of the projecting portion 52b and less tends to stagnate on an upper part of the weight 52. It is thus possible to effectively suppress toner stagnation around the coupled parts of the wound spring portion 51 and the weight 52.

Moreover, forming the projecting portion 52b in an upper end part of the inserted portion 52a makes it easy to press-fit the inserted portion 52a into the press-in portion 51a starting at the tip end of the projecting portion 52b. That is, the projecting portion 52b also provides a shape that guides the insertion of the inserted portion 52a into the press-in portion 51a.

There is no particular limitation on the inclination angle of the side face of the projecting portion 52b. Too small an inclination angle, however, limits the effect of suppressing toner stagnation. On the other hand, too large an inclination angle makes the weight 52 large along the up-down direction and incurs an increased cost. Preferably, the angle of the side face of the projecting portion 52b is from about 40° to about 60°.

While in the embodiment the projecting portion 52b is formed in a conical shape, the projecting portion 52b can be in any shape rising from the outer circumferential edge of an upper end part of the inserted portion 52a so as to taper off upward so that it can suppress toner stagnation. The projecting portion 52b can be, for example, in a pyramidal shape.

In the embodiment, the upper end of the press-in portion 51a (the highest point of the metal wire material forming the press-in portion 51a, indicated by a solid line L1 in FIG. 6) is located below the upper end of the inserted portion 52a (the boundary between the inserted portion 52a and the projecting portion 52b, indicated by a broken line L2 in FIG. 6).

Thus, the upper end of the press-in portion 51a does not reach up beyond the side face of the inserted portion 52a. This makes toner that slides down the side face of the projecting portion 52b less likely to stagnate in the gap between the press-in portion 51a and the projecting portion 52b. It is thus possible to more effectively suppress toner stagnation on an upper part of the weight 52.

The embodiment described above is not meant to limit the scope of the present disclosure, which thus allows for many modifications without departure from the spirit of the present disclosure. For example, while the above embodiment deals with a configuration where toner is supplied to a developing device 3a to 3d in which a stirring conveying chamber 21 and a feeding conveying chamber 22 are disposed side by side, a configuration is also possible where toner is supplied to a developing device 3a to 3d that has a stirring conveying chamber 21 and a feeding conveying chamber 22 disposed above the stirring conveying chamber 21. While the above embodiment deals with an example where developer is supplied from a feeding conveying screw 26 to a developing roller 30, this is not meant as any limitation on the present disclosure. A developer carrying member such as a magnetic roller can be additionally provided between the feeding conveying screw 26 and the developing roller 30 so that first the developer is supplied from the feeding conveying screw 26 to the magnetic roller or the like and then the toner is supplied from the magnetic roller or the like to the developing roller 30.

While the above embodiment deals with a toner supplying portion 32 that supplies toner from a toner container 4a to 4d to a developing device 3a to 3d, the toner conveying device according to the present disclosure is not limited to such a toner supplying portion 32 so long as it has a horizontal conveying portion disposed downstream of a vertical conveying portion. For example, in a configuration where an intermediate hopper for temporarily storing toner is provided between a toner container 4a to 4d (see FIG. 1) and a developing device 3a to 3d, the present disclosure can be applied to a toner conveying device that supplies toner from the toner container 4a to 4d to the intermediate hopper. It can also be applied to a waste toner conveying device that conveys waste toner from a cleaning device 7a to 7d (see FIG. 1) to a waste toner collection container (not shown).

The present disclosure can be applied not only to tandem-type color printers like the one shown in FIG. 1 but also to various types of image forming apparatuses such as digital or analog monochrome copiers, monochrome printers, color copiers, and facsimile machines provided with a toner conveying device in which a horizontal conveying portion is disposed downstream of a vertical conveying portion.

The present disclosure finds applications in toner conveying devices that have a vertical conveying portion and a horizontal conveying portion coupled to a lower end part of the vertical conveying portion. Based on the present disclosure, it is possible to provide a toner conveying device that can, with a configuration where toner stagnation in a vertical conveying portion is suppressed by use of a loosening member having a coil spring and a weight, suppress toner stagnation at the coupled parts of the coil spring and the weight, and to provide a developing device and an image forming apparatus provided with such a toner conveying device.

What is claimed is:

1. A toner conveying device comprising:
a vertical conveying portion having, formed in an upper end part thereof, an inlet port coupled to a body-side conveying passage in an image forming apparatus, the vertical conveying portion conveying toner, or developer containing the toner, carried in via the inlet port, by letting the toner or developer fall vertically;
a horizontal conveying portion coupled to a lower end part of the vertical conveying portion, the horizontal conveying portion conveying the toner or developer horizontally;
a conveying member having:
a rotation shaft disposed along a conveying direction of the toner or developer in the horizontal conveying portion; and
a conveying projection provided on an outer circumferential surface of the rotation shaft,
the conveying member rotating the rotation shaft to convey, with the conveying projection, the toner or developer in the horizontal conveying portion along a direction of the rotation shaft; and
a loosening member disposed in the vertical conveying portion so as to be vertically movable therein,
the toner conveying device being removably mounted in the image forming apparatus,
wherein
the loosening member includes:
a wound spring portion formed by curling a metal wire material into a spiral shape; and
a weight fixed to a lower end part of the wound spring portion,
the wound spring portion has, formed therein, a press-in portion in a hollow cylindrical shape in which turns of the metal wire material are put in close contact together, and
the weight has:
an inserted portion in a cylindrical shape with an outer diameter larger than an inner diameter of the press-in portion in a state with no external force acting thereon, the inserted portion being press-fitted in the press-in portion; and
a projecting portion rising from an outer circumferential edge of an upper end part of the inserted portion so as to taper off upward.

2. The toner conveying device according to claim 1, wherein
an upper end of the press-in portion is located below an upper end of the inserted portion.

3. A developing device comprising:
a developer container that stores developer containing toner;
a stirring conveying member that stirs and conveys the developer in the developer container;
a developer carrying member rotatably supported on the developer container, the developer carrying member carrying the developer in the developer container; and
the toner conveying device according to claim 1 as a toner supplying portion that supplies the toner to the developer container.

4. An image forming apparatus comprising:
an image carrying member having a photosensitive layer formed on a surface thereof; and
the developing device according to claim 3 that develops an electrostatic latent image formed on the surface of the image carrying member into a toner image.
